(19) United States
(12) Patent Application Publication
(10) Pub. No.: US 2004/0073544 A1
(43) Pub. Date: Apr. 15, 2004

(54) Method of quantizing bin value of color histogram

(75) Inventors: Heon Jun Kim, Sungnam-si (KR); Jin Soo Lee, Seoul (KR)

Correspondence Address: FLESHNER & KIM, LLP, P.O. BOX 221200, CHANTILLY, VA, 20153, US

(73) Assignee: LG Electronics Inc.

(21) Appl. No.: 10/677,376

(22) Filed: Oct. 3, 2003

(30) Foreign Application Priority Data
Oct. 7, 2002 (KR) 61089/2002

(51) Int. Cl. G06F 7/00

(52) U.S. Cl. 707/3

(57) ABSTRACT

The present invention relates to methods and apparatus for quantizing a bin value of a histogram. A method according to the present invention can include dividing a bin value into N+1 regions using N threshold values; and dividing and quantizing each respective one of the divided regions uniformly and with greater resolution to yield smaller divisions as a region is nearer to zero. For example, the bin value can be divided into six regions using five non-uniform threshold values (th1, th2, th3, th4 and th5), which can be set to 0.000000001, 0.037, 0.08, 0.195, and 0.32, respectively. A first region (≦th1) can be regarded as one value. The second region through the sixth region can be uniformly divided, for example into 25 levels 20 levels, 35 levels, 35 levels and 140 levels, respectively. Accordingly, the bin value can be represented with 256 values.

### BACKGROUND OF THE INVENTION

1. Field of the Invention

The present invention relates to a method of quantizing a bin value of a color histogram, and in particular, to a method of quantizing a bin value of a color histogram that is used as characteristic information of moving pictures or image data for the purpose of multimedia search.

2. Background of the Related Art

With the advance of content based multimedia search technology, a multimedia feature determining the search performance has been actively researched. In most popular search engines, global and local color information, texture information and the like are used for an image search. Among them, the color information is more important in the image search. Accordingly, more effective color features for searching are under development and an attempt to develop the more effective color space is also being made.

The color histogram is most widely used as the color information. The color histogram is information representing a color distribution of multimedia data such as images, and the number of bins is determined by how to quantize the color space.

Although the bin value is generally represented in a fraction, it can be also represented using N bits that are less than the fractional representation space for better performance and spatial efficiency. For example, as is well known, if the bin value is represented using eight bits, i.e., the fraction value between 0 and 1 is represented with 256 numbers, the space can be saved without any degradation of performance.

In related art quantizing methods, there is a normalized quantizing method and a non-normalized quantizing method. According to the normalized quantizing method, the value between 0 and 1 is uniformly divided and quantized. Meanwhile, according to the non-normalized quantizing method, the value is nonuniformly divided and quantized.

However, in the case of the multimedia search using the color histogram, there is a problem of the spatial efficiency in the number of bits, which represents a bin value. Accordingly, there is a demand for a technology of enhancing the searching performance and representing the bin value using small number of bits. Additionally, there is a demand for the quantization technology in which the bin value “zero” affecting the multimedia search performance is considered as a meaningful value.

The above references are incorporated by reference herein where appropriate for appropriate teachings of additional or alternative details, features and/or technical background.

### SUMMARY OF THE INVENTION

An object of the invention is to solve at least the above problems and/or disadvantages and to provide at least the advantages described hereinafter.

Another object of the present invention is to provide a method and apparatus for quantizing a bin value of a color histogram that substantially obviates one or more problems due to limitations and disadvantages of the related art.

Another object of the present invention is to provide a method and apparatus of quantizing a bin value of a color histogram in a multimedia search using a histogram such as a color histogram, in which the spatial efficiency is enhanced by representing a bin value using a small number of bits and the searching performance is also improved.

Another object of the present invention is to provide a method of quantizing a bin value of a color histogram in a multimedia search using a histogram such as a color histogram, in which the desired or optimized number of bits is allocated considering a histogram characteristic, to enhance a capability to represent quantized values and improve the searching performance.

Another object of the present invention is to provide a method of quantizing a bin value of a color histogram in order to represent the bin value of the histogram using predetermined bits, in which quantizing regions of the bin value of the color histogram are set nonuniformly and an uniform quantizing is performed more finely in the nonuniformly set quantizing regions as the bin value goes to zero.

Another object of the present invention is to provide a method and apparatus for quantizing a bin value of a color histogram in a multimedia search using a histogram such as a color histogram, in which the value nearer to zero is quantized more finely to enhance the capability to represent quantized values.

Another object of the present invention is to provide a method of quantizing a bin value of a color histogram in a multimedia search using a histogram such as a color histogram, in which the bin value “zero” is considered as a meaningful value, thereby improving a searching performance.

To achieve at least the above objects and other advantages in a whole or in part and in accordance with the purpose of the invention, as embodied and broadly described herein, there is provided a method of quantizing a bin value of a color histogram that includes dividing a bin value into N+1 regions using N threshold values, and dividing and quantizing the divided regions uniformly and more finely as a region is nearer to zero. The bin value can be represented with the small number of bits and the bin value is quantized considering that the frequency increases as the bin value goes to zero so that the searching performance and the capability to represent quantized values are enhanced and the spatial efficiency is improved in the representation of the bin value.

To further achieve at least the above objects and other advantages in a whole or in part and in accordance with the purpose of the invention, as embodied and broadly described herein, there is provided a method of quantizing a bin value of a color histogram, the method includes separating a bin value of a histogram of video or image data into N+1 non-uniform regions using N threshold values, and representing a bin value within each of the regions uniformly, wherein the respective uniform bin value within said each region is smaller as the region is nearer to zero.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a diagram that shows an exemplary percentage distribution of the number of bins with respect to a bin value;

FIG. 2 is a diagram showing a method of quantizing a bin value according to a preferred embodiment of the present invention; and

FIG. 3 is an exemplary quantization table of bin values according to a preferred embodiment of the present invention.

### DETAILED DESCRIPTION OF PREFERRED EMBODIMENTS

Preferred embodiments of the present invention will now be described, examples of which are illustrated in the accompanying drawings. Wherever possible, the same reference numbers will be used throughout the drawings to refer to the same or like parts.

As described above, a non-normalized quantizing method can obtain higher performance than a normalized quantizing method or the fractional representation. For example, a region of an important bin value is finely divided and the region of less value is sparsely divided, so that the performance of quantization is enhanced.

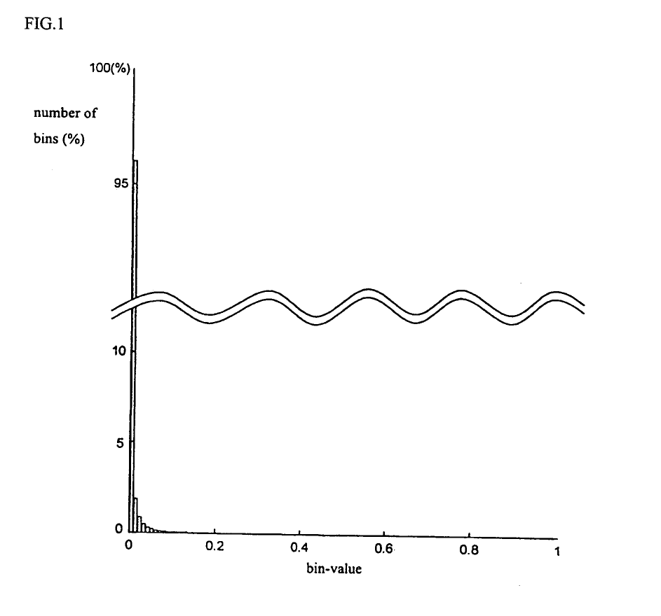

For example, in the case of the histogram, it is of little or no consequence that a region of bin values of more than 0.2 is finely divided since most bin values are less than 0.2. In the bin values below the threshold value, a frequency increases as the value goes to zero. FIG. 1 shows the above-described characteristic. Accordingly, it is more effective to perform the quantizing more finely as the bin value goes to zero. Hence, the quantizing of the bin value using the non-normalized quantizing method can be very useful. However, if the number of bits is allocated uniformly with respect to the nonuniform quantizing region, the representation capability is degraded in the relatively less important regions and the relatively more important regions. Further, “zero” in the bin value has a greatly different meaning from “non-zero” in the bin value. In other words, the difference between 0 and 0.1 can be analyzed with a great difference from a difference between 0.1 and 0.5 because the difference between 0 and 0.1 means whether a color corresponding to the bin exists or not, which is a different meaning from whether a number of colors within the bin values is large or small.

In a method of quantizing a bin value of a color histogram according to embodiments of the present invention, a bin value is divided into N+1 regions using N threshold values, where N is a positive integer. The N+1 regions can be non-uniformly divided. Among the divided regions, regions that are nearer to “zero” are more finely and uniformly divided. Preferably, the number of bin values total a prescribed or random integer and then are quantized.

In an embodiment of the present invention, a first threshold value of the N threshold values can be set to zero or almost zero. A first region of the N+1 regions is preferably regarded as one value. The number N is 5 and the threshold values th1, th2, th3, th4 and th5 are set to 0.000000001, 0.037, 0.08, 0.195, and 0.32, respectively. However, the present invention is not intended to be so limited as other specific threshold values can be used and other values for N can be used.

In an embodiment of the present invention, a first region (≦th1) is regarded as one value; a second region (>th1 and ≦th2) is divided uniformly into 25 levels; a third region (>th2 and ≦th3) is divided uniformly into 20 levels; a fourth region (>th3 and ≦th4) is divided into 35 levels; and a last region (>th5) is divided uniformly into 140 levels. Accordingly, in this embodiment, the bin value is represented using 256 levels. However, the present invention is not intended to be so limited. For example, other prescribed numbers of total levels that can be quantized and other uniform divisions with determined regions can be used.

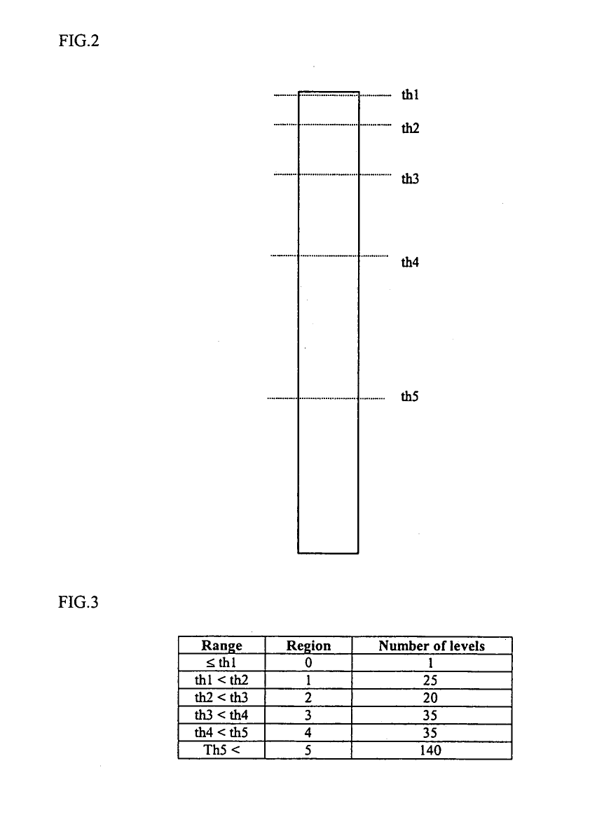

FIG. 2 is a diagram showing an embodiment of a method of quantizing a bin value according to the present invention. As shown in FIG. 2, in order to quantize the bin value, five threshold values th1, th2, th3, th4 and th5 (in case of N=5) are used. Since N+1=6, the bin value is divided into a total of six regions. However, the present invention is not intended to be so limited.

As shown in FIG. 2, the remaining five regions other than the first region (≦th1) are again each preferably uniformly divided as many times as a predetermined integer to quantize the entire bin value. In FIG. 2, the first threshold value (th1) is preferably zero or any value that is almost zero. The first region (≦th1), which is equal to or less than the threshold value th1, means the existence of a color corresponding to the bin. Therefore, the first region, which is equal to or less than the first threshold value th1, is not further divided but represented with one bin value.

The remaining five regions shown in FIG. 2, that is, the second region (>th1 and ≦th2), the third region (>th2 and ≦th3), the fourth region (>th3 and ≦th4),the fifth region (>th4 and ≦th5) and the sixth region (>th5) can be uniformly divided by corresponding predetermined integers. In one embodiment according to the present invention, the five threshold values th1, th2, th3, th4 and th5 are preferably set as 0.000000001, 0.037, 0.08, 0.195, 0.32, respectively.

One embodiment of a method of dividing the six regions will now be described. As described above, the first region (≦th1) can be represented with one value; the second region (>th1 and ≦th2) is evenly divided into 25 levels and represented with 25 values; the third region (>th2 and ≦th3) is evenly divided into 20 levels and represented with 20 values; the fourth region (>th3 and ≦th4) is evenly divided into 35 levels and represented with 35 values; the fifth region (>th4 and ≦th5) is evenly divided into 35 levels and represented with 35 values; and the last region (>th5) is evenly divided into 140 levels and represented with 140 values.

As described above, with respect to each of the six regions divided nonuniformly by five threshold values th1, th2, th3, th4 and th5, the bin value within each region are respectively uniformly divided and represented with 256 values. This means that the bin value can be represented with eight binary bits. In other words, the bin values are represented with 256 values using eight binary bits. However, the present invention is not intended to be so limited.

In FIG. 3, there is shown an exemplary table showing six regions according to the five threshold values and corresponding values used to uniformly divide the regions. As shown in FIG. 3, in the quantization for representing the bin values of the histogram with the predetermined bits, the N threshold values are defined to divide the bin value into N+1 regions and each region is uniformly divided according to a predetermined integer. As the region is nearer to zero, the region is divided more finely. Thus, in the bins representing the histogram, preferably an overall resolution increases as the bin is located closer to zero. A first threshold value nearest to zero of the N threshold values is preferably allocated to zero or an infinitesimal value that is almost zero. The first region nearest to zero is not divided but represented with one bin value. Accordingly, by representing the bin value with the small number of bits, the spatial efficiency can be enhanced and the searching performance can also be improved.

The bin value is quantized considering that the frequency increases as the bin value goes to zero so that the capability to represent quantized values is enhanced. Further, “zero” is considered as a meaningful value. Accordingly, a searching performance can be increased.

As shown in FIG. 3, in at least one embodiment, as each of the regions divided by the N nonuniform threshold values thₙ is nearer to zero, widths of the corresponding regions are preferably narrower than those of regions that are further from zero or a prescribed value. In other words, thₙ₊₁−thₙ<thₙ₊₂−thₙ₊₁(1≦n≦N).

According to one embodiment of the present invention, the bin value of the histogram is divided into six regions using five threshold values th1, th2, th3, th4 and th5. The five threshold values, th1, th2, th3, th4 and th5 are set to 0.000000001, 0.037, 0.08, 0.195, and 0.32, respectively. The first region (≦th1) is represented using only a single value, and the second region (>th1 and ≦th2), the third region (>th2 and ≦th3), the fourth region (>th3 and ≦th4), the fifth region (>th4 and ≦th5) and the last region (>th5) are uniformly divided into 25 levels, 20 levels, 35 levels, 35 levels and 140 levels, respectively. In other words, the bin value is represented with 256 values. This means that the bin value can be represented using eight bits.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A method of quantizing a bin value of a color histogram, the method comprising:
(a) dividing a bin value into N+1 regions using N threshold values; and
(b) dividing and quantizing the divided regions uniformly and more finely with respect to each region that is nearer to zero.

2. The method according to claim 1, wherein a first threshold value of the N threshold values is zero or almost zero.

3. The method according to claim 1, wherein a first region of the N+1 regions is regarded as one value.

4. The method according to claim 1, wherein at least one of the N+1 regions is represented by a single value.

5. The method according to claim 1, wherein the N+1 regions are non-uniform regions.

6. The method according to claim 1, wherein the number N of the threshold values is 5 and the N threshold values are set as follows:
a first threshold value (th1) is 0.000000001;
a second threshold value (th2) is 0.037;
a third threshold value (th3) is 0.08;
a fourth threshold value (th4) is 0.195; and
a fifth threshold value (th5) is 0.32.

7. The method according to claim 6, wherein the number N of the threshold values is 5;
a first region (≦th1) is regarded as one value;
a second region (>th1 and ≦th2) is uniformly divided into 25 levels;
a third region (>th2 and ≦th3) is uniformly divided into 20 levels;
a fourth region (>th3 and ≦th4) is uniformly divided into 35 levels;
a fifth region (>th4 and ≦th5) is uniformly divided into 35 levels; and
a sixth region (>th5) is uniformly divided into 140 levels, and wherein the bin value is represented using a total of 256 levels.

8. The method according to claim 1, wherein the number N of the threshold values is 5;
a first region (≦th1) is regarded as one value;
a second region (>th1 and ≦th2) is uniformly divided into 25 levels;
a third region (>th2 and ≦th3) is uniformly divided into 20 levels;
a fourth region (>th3 and ≦th4) is uniformly divided into 35 levels;
a fifth region (>th4 and ≦th5) is uniformly divided into 35 levels; and
a sixth region (>th5) is uniformly divided into 140 levels, wherein the bin value is represented using a total of 256 levels, where th1, th2, th3, th4 and th5 are the threshold values and th1≦th2≦th3≦th4≦th5.

9. A method of quantizing a bin value of a color histogram, the method comprising:
(a) separating a bin value of a histogram of video or image data into N+1 non-uniform regions using N threshold values; and
(b) representing a bin value within each of the regions uniformly, wherein the respective uniform bin value within said each region is smaller as the region is nearer to zero.

10. The method according to claim 9, wherein a first region that is nearest to zero is represented using a single bin value within the first region.

11. The method according to claim 9, wherein remaining regions other than a first region that is nearest to zero are uniformly divided by prescribed corresponding integers to obtain the bit value within said each of the regions.

12. The method of claim 11, wherein at least two of the prescribed corresponding integers are not equal in value.

13. The method according to claim 9, wherein the regions are separated by the N nonuniform threshold values (thₙ), wherein widths of regions that are closer to zero are narrower than those of regions that are farther away from zero, and wherein (thₙ₊₁−thₙ<thₙ₊₂−thₙ₊₁(1≦n≦N)).

14. The method according to claim 9, wherein the regions are divided nonuniformly by the N threshold values and each of the nonuniformly divided regions is divided uniformly, and the bin values within the regions are represented with eight bits.

15. The method of claim 14, wherein the eight bits represent 256 values.

16. The method of claim 9, wherein the bin values within the regions are quantized.
